(19) United States
(12) Patent Application Publication
(10) Pub. No.: US 2026/0006219 A1
(43) Pub. Date: Jan. 1, 2026

(54) ON PAIRWISE MERGE CANDIDATES

(71) Applicant: Nokia Technologies Oy, Espoo (FI)

(72) Inventors: Seungwook HONG, San Diego, CA (US); Limin WANG, San Diego, CA (US); Krit PANUSOPONE, San Diego, CA (US)

(21) Appl. No.: 19/254,801

(22) Filed: Jun. 30, 2025

Related U.S. Application Data
(60) Provisional application No. 63/666,617, filed on Jul. 1, 2024.

(51) Int. Cl. H04N 19/169

(52) U.S. Cl. CPC H04N 19/169

(57) ABSTRACT

An apparatus configured to: determine a plurality of pairwise merge candidates for a current coding unit based on a list of merge candidates sorted according to template cost, wherein multiple pairwise merge candidates are determined for respective merge candidates of the sorted list of merge candidates; and select at least one pairwise merge candidate of the plurality of pairwise merge candidates based, at least partially, on an averaged template cost of the respective pairwise merge candidates of the at least one selected pairwise merge candidate.

### TECHNICAL FIELD

The example and non-limiting embodiments relate generally to merge prediction with respect to video coding and, more particularly, to selection of pairwise merge candidates.

### BACKGROUND

It is known, in the enhanced compression model (ECM) built on top of versatile video coding (VVC), to calculate pairwise merge candidates based on a merge candidate with a smallest template cost.

### SUMMARY

The following summary is merely intended to be illustrative. The summary is not intended to limit the scope of the claims.

In accordance with one aspect, an apparatus comprising: at least one processor; and at least one memory storing instructions that, when executed with the at least one processor, cause the apparatus at least to: determine a plurality of pairwise merge candidates for a current coding unit based on a list of merge candidates sorted according to template cost, wherein multiple pairwise merge candidates are determined for respective merge candidates of the sorted list of merge candidates; and select at least one pairwise merge candidate of the plurality of pairwise merge candidates based, at least partially, on an averaged template cost of the respective pairwise merge candidates of the at least one selected pairwise merge candidate.

In accordance with one aspect, a method comprising: determining a plurality of pairwise merge candidates for a current coding unit based on a list of merge candidates sorted according to template cost, wherein multiple pairwise merge candidates are determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

In accordance with one aspect, a computer-readable medium comprising program instructions stored thereon for performing at least the following: determining a plurality of pairwise merge candidates for a current coding unit based on a list of merge candidates sorted according to template cost, wherein multiple pairwise merge candidates are determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

In accordance with one aspect, an apparatus comprising means for: determining a plurality of pairwise merge candidates for a current coding unit based on a list of merge candidates sorted according to template cost, wherein multiple pairwise merge candidates are determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the example embodiments may be practiced;

FIG. 3 is a diagram illustrating features as described herein;

FIG. 4 is a diagram illustrating features as described herein; and

FIG. 5 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5GC 5G core network
AR augmented reality
CABAC context-adaptive binary arithmetic coding
CDMA code division multiple access
CPU central processing unit
CRAN cloud radio access network
CTU coding tree unit
CU coding unit
ECM enhanced model compression
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDMA frequency division multiple access
gNB (or gNodeB) base station for 5G/NR, i.e., a node providing NR user plane and control plane protocol terminations towards the UE, and connected via the NG interface to the 5GC
GPU graphical processing unit
GSM global systems for mobile communications
HMD head-mounted display
HMVP history-based motion vector prediction
IBC intra block copy
IEEE Institute of Electrical and Electronics Engineers
IMD integrated messaging device
IMS instant messaging service
IoT Internet of Things
JVET Joint Video Experts Team
LTE long term evolution
MMS multimedia messaging service
MPEG-I Moving Picture Experts Group immersive codec family
MR mixed reality
MVD motion vector delta
MVP motion vector prediction
ng or NG new generation
ng-eNB or NG-eNB new generation eNB
NR new radio
N/W or NW network
O-RAN open radio access network
PC personal computer
PDA personal digital assistant
SAD sum of absolute difference
SMS short messaging service
TCP-IP transmission control protocol-internet protocol
TDMA time division multiple access
TMP template matching prediction
UMTS universal mobile telecommunications system
USB universal serial bus
UE user equipment (e.g., a wireless, typically mobile device)
VNR virtualized network function
VR virtual reality
VVC versatile video coding
WLAN wireless local area network

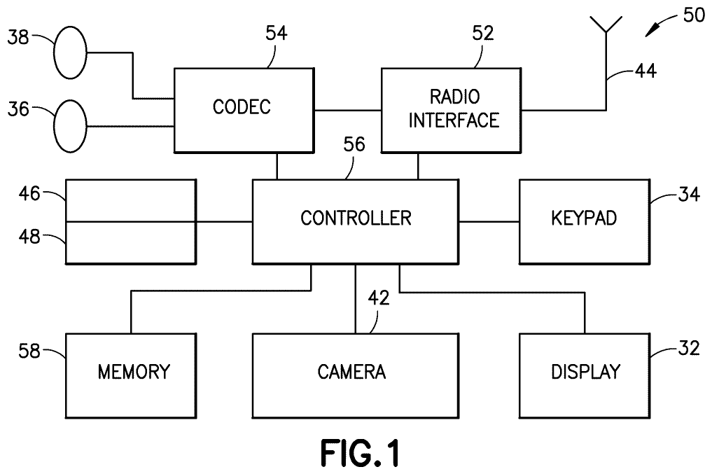

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that example embodiments of the present disclosure may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in example embodiments of the present disclosure may be any one of: an earpiece, speaker, or an analogue audio or digital audio output connection. The electronic device 50 may also comprise a battery (or in other example embodiments of the present disclosure the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other example embodiments of the present disclosure the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in example embodiments of the present disclosure may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

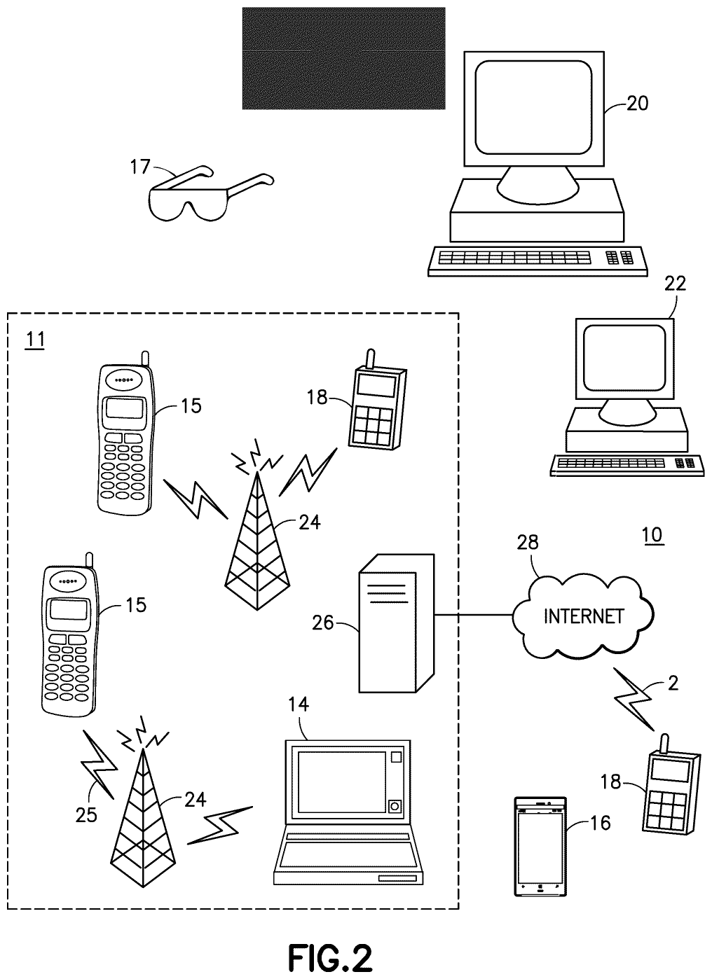

With respect to FIG. 2, an example of a system within which example embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet. A wireless network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors and memories, and also such virtualized entities create technical effects.

It may also be noted that operations of example embodiments of the present disclosure may be carried out by a plurality of cooperating devices (e.g. cRAN).

The system 10 may include both wired and wireless communication devices and/or electronic devices suitable for implementing example embodiments of the present disclosure.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The example embodiments of the present disclosure may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The example embodiments of the present disclosure may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, access point, access node, other node, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802.11, 3GPP Narrowband IT and any similar wireless communication technology. A communications device involved in implementing various example embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

Features as described herein may generally relate to processing of image sequences, or videos. Versatile Video Coding (VVC) is a new international video coding standard, and Enhanced Compression Model (ECM), built on top of VVC, is potentially a future video coding standard currently under development sponsored by JVET. In VVC and ECM, a video sequence comprises a plurality of pictures. Both VVC and ECM are block-based video coding standards, where an input picture is divided into Coding Tree Units (CTUs), and each CTU may be further split into Coding Units (CUs). A CU (or block) is coded in either inter-coding mode or intra-coding mode.

If the block is coded in inter-coding mode, the encoder searches for a temporal prediction block in reference picture(s) and signals the decoder an indication of how to find the same prediction block in reference picture(s) at the decoder end.

If the block is coded in intra-coding mode, the encoder constructs a spatial prediction block from the current picture and signals the decoder an indication of how to form the same spatial prediction block from the current picture at the decoder end.

For a current inter-CU in a current picture, the associated temporal prediction block in reference pictures is represented by motion information (e.g. motion vectors, reference pictures, reference lists, etc.) with respect to the current CU in the current picture. The encoder signals the motion information to the decoder, and the decoder uses the motion information to form the temporal prediction block from reference pictures.

In VVC and ECM, for a current CU, its motion information may consist of two parts: motion information prediction (e.g. motion vector prediction (MVP)) and motion information delta (e.g. motion vector delta (MVD)). For a current CU, its motion information prediction is derived from the motion information of the past inter coded CUs in the current picture or in reference pictures. The motion information delta is often coded in an explicit manner.

For each CU, an encoder may search an (intra or inter) prediction block, which may be constructed from the reconstructed pixels in the coded area of the current picture, or from the reconstructed pixels in the past coded pictures. The encoder may subtract the (intra or inter) prediction block from the CU. The resulting residual block may then be transformed, and the transformed coefficients may be quantized. The quantized transformed coefficients may be context-adaptive binary arithmetic coding (CABAC) coded into a compressed bitstream.

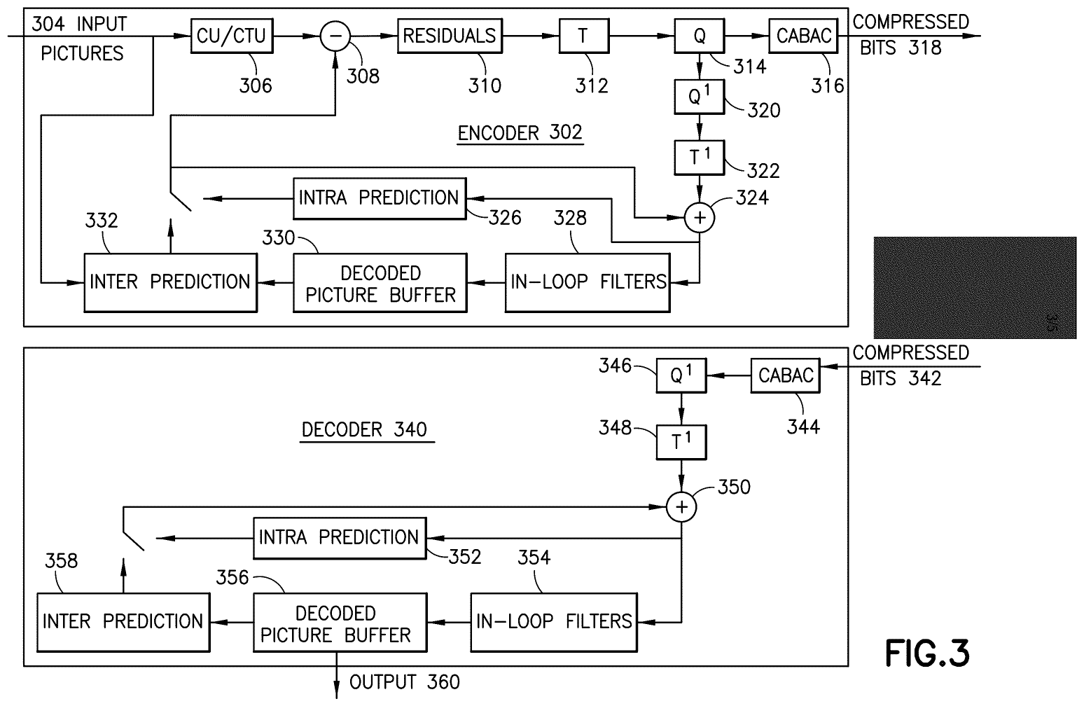

FIG. 3 illustrates diagrams of an example encoder (302) and an example decoder (340). In the encoder (302), input pictures (304) may be divided into a CU or CTU (306), and a prediction block may be subtracted (308) to form a residual (310), which may be transformed (312) and quantized (314) before being coding (316) as compressed bits (318) into a bitstream. The quantized transformed coefficients may also be dequantized/inverse quantized (320) and inverse transformed (322), and combined with the output of a prediction block (324). The result may then be used in intra prediction (326) and may be (e.g. in parallel) in-loop filtered (328), included in a decoded picture buffer (330), and used in inter prediction (332). In the decoder (340), compressed bits (342) may be decoded (344), dequantized (346), inverse transformed (348), and combined with the output of a prediction block (350). The result may then be used in intra prediction (352) and may be (e.g. in parallel) in-looped filtered (354), included in a decoded picture buffer (356), and used in inter prediction (358). The contents of the decoded picture buffer (356) may be output (360).

As shown in FIG. 3, the decoder (340) may actually be part of the coding loop of the encoder (302) in a reverse way (e.g. 320-332). The quantized transformed coefficients in the encoder (e.g. after quantization block (314), or the output of CABAC (344) in the decoder) may be dequantized (320, 346) and inverse transformed (322, 348), generating the coded residual block (e.g. 324, 350). The (intra or inter) prediction block (326, 332, 352, 358) may then be added to the coded residual block (324, 350), generating the reconstructed block. In-loop filtering may be performed over the reconstructed block (328, 354), forming the final reconstructed block. The final reconstructed blocks may be stored in a decoded picture buffer (330, 356) for output (360), as well as for possible use of future coding.

In VVC and ECM, inter prediction uses the past coded pictures as reference pictures. The reference pictures may comprise the final reconstructed pixels after in-loop filtering, which may have the technical effect of providing more accurate prediction. In contrast, intra prediction uses the coded area of the current picture before in-loop filtering as the reference area. The reference area comprises the non-final reconstructed pixels before in-loop filtering, which may have the technical effect of providing less accurate prediction.

One of the coding tools supported in VCC and ECM is intra block copy (IBC). For a current CU, IBC searches for a prediction block in a reference area of the current picture. The reference area is the coded area of the current picture before in-loop filtering. Accordingly, the reference area comprises the non-final reconstructed pixels, which may mean less accurate prediction. ECM has increased the reference area for IBC significantly, as compared to VVC. For example, the reference area may cover many coded CUs/CTUs, including all the coded CUs in the current CTU, all the coded CTUs in the current CTU row (n), all the coded CTUs in the above CTU row (n−1), and some or all of the coded CTUs in CTU row (n−2). A block/CU inside the reference area may be the prediction block for the current CU.

A special intra prediction mode introduced in ECM is intra template matching prediction (Intra TMP). In intra TMP, for a current CU, a template may be defined with the CU's left and above neighboring pixels. For a current CU in intra TMP mode, the encoder searches for the most similar template to the CU's template within a predefined search range inside the coded area of the current picture and uses the corresponding block as a prediction block. In the current ECM design, both the current CU's template and the associated search range for intra TMP may comprise the reconstructed pixels before in-loop filtering, or the non-final reconstructed pixels.

While example embodiments of the present disclosure may be described with respect to inter coding, this is not limiting. Example embodiments of the present disclosure may also be applicable to intra-frame coding, for example in the context of IBC and/or intra-TMP.

In the present disclosure, the term “reference area” may be used for an area over which intra prediction is performed. For example, the “reference area” for IBC is an area over which a prediction block is searched for a current CU. In other words, the prediction block for a current CU is found in the reference area. The “search range” for intra TMP is an area over which a best template is searched for the template of a current CU. In other words, a best template for a current CU is found in the search range. Both “reference area” for IBC and “search area” for intra TMP may be considered as “reference area” for intra prediction in the present disclosure.

Features as described herein may generally relate to motion information prediction. VVC and ECM support many new and refined coding tools for deriving the motion information prediction for a current CU. One of the coding tools is merge prediction, in which for a current CU, both encoder and decoder construct a same list of merge candidates. The merge candidates hold the motion information of the past inter coded CUs around the current CU both spatially and temporally. The encoder may select a merge candidate (i.e. motion information) from the merge candidate list for the current CU, and may signal to the decoder which merge candidate in the merge candidate list is to be used for the current CU.

For a current CU in a current picture, a merge candidate list is constructed by including the following types of candidates: spatial merge candidates; temporal merge candidates; non-adjacent merge candidates; history-based merge candidates; history-based merge candidates from Affine history-based motion vector prediction (HMVP); and/or pairwise merge candidates.

An initial merge candidate list may be formed without pairwise merge candidates. Pairwise candidates may be formed by averaging some merge candidates in the initial merge candidate list.

For a current CU, a merge candidate list is formed, where there can be up to four pairwise merge candidates. The pairwise merge candidates may be derived from averaging other merge candidates.

In the current design of VVC and ECM, the pairwise merge candidates constructed for a current CU may not have the smallest template costs, against the template of the current CU, as compared to other pairs of merge candidates.

In an example embodiment, pairwise candidates may be derived from any pairs of merge candidates including spatial merge candidates, TMVP merge candidate, non-adjacent spatial merge candidates, HMVP merge candidates, and affine HMVP merge candidates. In an example embodiment, the pairwise candidates may include the pairwise candidates with the smallest template costs in the merge candidate list, as pairwise merge candidates.

In VVC and ECM, for a current CU, pairwise merge candidates are derived from averaging the merge candidate having the smallest template cost against the template of the current CU with other merge candidates. Specifically, for a current CU, the following steps are performed:
Collect merge candidates, including spatial merge candidates, TMVP, non-adjacent merge candidates, HMVP, Affine HMVPs, etc.
Calculate the costs of each merge candidate's template against the template of the current CU.
Sort the merge candidates based on their template costs, with the merge candidate having the lowest template cost appearing first in the sorted list.
Take the merge candidate with the smallest template cost and average it with up to four merge candidates with the next smallest costs, if they are available.
The averaged merge candidates are included, as pairwise merge candidates, in the merge candidate list.

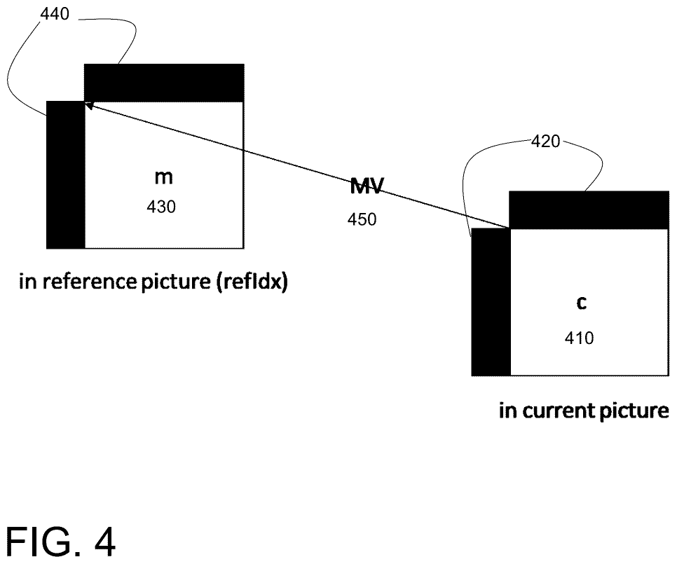

Referring now to FIG. 4, illustrated is an example of how the template cost of a merge candidate may be calculated based on a difference between the templates of the merge candidate and the current CU. A current CU (c, 410) in the current picture may have many merge candidates, including spatial merge candidates, TMVP merge candidates, non-adjacent merge candidates, HMVP merge candidates, Affine HMVP merge candidates, etc. Each merge candidate contains motion information including motion vector, reference picture index, reference picture list, etc. With the motion information of a merge candidate, the encoder and the decoder can find the corresponding prediction block (m, 430) in the reference picture. The left and above reconstructed neighboring pixels of the current CU (410) and the corresponding prediction block form the template (Tc, 420) of the current CU (410) and the template (Tm, 440) of the corresponding prediction block (430). The template cost of a merge candidate against the current CU is defined as the difference between its template and the template of the current CU:

$$template cost = diff ( Tc - Tm ) \qquad Eq . 1$$

One metric for the difference is sum of absolute difference (SAD).

Let cand [i], i=0, 1, 2, . . . , denote the sorted merge candidates, with cand [0] having the smallest template cost. The pairwise merge candidates may be calculated according to the following pseudo code:

```
idx = 0; // index for pairwise merge candidates
n = cand.size( ) //the number of merge candidates
m = n − 1;
for( j = 1; j <= min(m, 4); j++ ) {
{
for (k = L0 to L1) { // L0: RefPicList[0], L1: RefPicList[1]
  pair.cand[idx].refIdx[k] = −1;
  if (cand[0].refIdx[k] == cand[j].refIdx[k])
    pair.cand[idx].refIdx[k] = cand[0].refIdx[k]
  pair.cand[idx].mv[k] = ( cand[0].mv[k] + cand[j].mv[k] ) >> 1
  else if (cand[0].refIdx[k] > 0)
    pair.cand[idx].refIdx[k] = cand[0].refIdx[k]
  pair.cand[idx].mv[k] = cand[0].mv[k]
  else if (cand[j].refIdx[k] > 0)
    pair.cand[idx].refIdx[k] = cand[j].refIdx[k]
    pair.cand[idx].mv[k] = cand[j].mv[k]
}
if (pair.cand[idx].refIdx[0] > 0 ∥ pair.cand[idx].refIdx[1] > 0)
  idx++
}
```

In the exemplary pseudo code, the variable mv may refer to a motion vector, and the variable refIdx may reference to a reference (picture) index.

In ECM, up to four pairs are included, as pairwise merge candidates, in the merge candidate list. It is possible for fewer pairwise merge candidates to be included in the merge candidate list; this may depend on the size of empty slots in the merge candidate list. Alternatively, a greater number of pairwise merge candidates may be included in the merge candidate list, for example according to a different standard or compression model.

In the exemplary pseudo code, pairwise merge candidates may be constructed from the merge candidate with the smallest/lowest template cost, averaged with the next four merge candidates with smallest template cost.

In an example, the following may be a list of the sorted merge candidates, with merge candidate [0] having the smallest template cost (96) against the current CU:
[0] mv(−12,−9) refIdx:0 mv(12,9) refIdx:0 cost:96
[1] mv(−14,−12) refIdx:0 mv(14,12) refIdx:0 cost:110
[2] mv(−7,−9) refIdx:0 mv(7,9) refIdx:0 cost:294
[3] mv(−8,−8) refIdx:0 mv(8,8) refIdx:0 cost:318
[4] mv(−7,−7) refIdx:0 mv(7,7) refIdx:0 cost:456
[5] mv(0,0) refIdx:−1 mv(7,9) refIdx:0 cost:866
[6] mv(−7,−9) refIdx:0 mv(0,0) refIdx:−1 cost:920
[7] mv(0,0) refIdx:−1 mv(8,8) refIdx:0 cost:926
[8] mv(−8,−8) refIdx:0 mv(0,0) refIdx:−1 cost:1020
[9] mv(−7,−7) refIdx:0 mv(0,0) refIdx:−1 cost:1296

In ECM, pairwise merge candidates are derived from averaging merge candidate [0] with next four merge candidates [1,2,3,4], if they are available, as shown below:
Pair (0,1): (−13,−10) refIdx:0, (13,10) refIdx:0 cost:206
Pair (0,2): (−9,−9) refIdx:0, (9,9) refIdx:0 cost:390
Pair (0,3): (−10,−8) refIdx:0, (10,8) refIdx:0 cost:414
Pair (0,4): (−9,−8) refIdx:0, (9,8) refIdx:0 cost:552

As seen, pairwise merge candidates may be generated without taking their (averaged) template costs into consideration.

In an example embodiment, for a current CU, pairwise candidates may be derived from pairs of the merge candidates. In an example embodiment, the pairwise candidates with the smallest template costs, against the template cost of the current CU, may be included in the merge candidate list as pairwise merge candidates.

In an example embodiment, for a current CU, the following steps may be performed:
Merge candidates may be collected, including for example spatial merge candidates, TMVP, non-adjacent merge candidates, HMVP, and/or Affine HMVP.
The costs of each merge candidate's template may be calculated against the template of the current CU.
The merge candidates may be sorted based on their template costs, with the merge candidate having the lowest template cost appearing first in the sorted list.
A pairwise candidate may be derived from each possible pair of merge candidates (e.g. average the pair or select either one of the pair (e.g. any of the pairs) based upon certain conditions, etc.).
Pairwise candidates with the smallest template costs against the template of the current CU, may be included as pairwise merge candidates in a merge candidate list.

In an example embodiment, cand [i], i=0, 1, 2, . . . , may denote the sorted merge candidates, with cand [0] having the smallest template cost. In an example embodiment, the pairwise merge candidates may be calculated according to the following pseudo code:

```
idx = 0; // index for pairwise merge candidates
{
  n = cand.size( )
  for( i = 0; i < n − 1; i++ ) {
    for( j = i+1; j < n; j++ ) {
    pair.cand[idx].refIdx[k] = −1;
    for (k = L0 to L1) { // L0: RefPicList[0], L1: RefPicList[1]
      if (cand[i].refIdx[k] == cand[j].refIdx[k])
      pair.cand[idx].refIdx[k] = cand[i].refIdx[k]
    pair.cand[idx].mv[k] = ( cand[i].mv[k] + cand[j].mv[k] ) >> 1
      else if (cand[i].refIdx[k] > 0)
    pair.cand[idx].refIdx[k] = cand[i].refIdx[k]
      pair.cand[idx].mv[k] = cand[i].mv[k]
      else if (cand[j].refIdx[k] > 0)
    pair.cand[idx].refIdx[k] = cand[j].refIdx[k]
      pair.cand[idx].mv[k] = cand[j].mv[k]
    } // k
    if (pair.cand[idx].refIdx[0] > 0 ∥ pair.cand[idx].refIdx[1] > 0)
    idx++
  } // j
} // i
}
```

In the exemplary pseudo code, pairwise merge candidates may be constructed from each unique combination of merge candidates. For example, the combination formula may give the total number of potential pairwise merge candidates that may be constructed using the exemplary pseudo code:

$$\frac{n !}{k ! ( n - k ) !} \qquad Eq . 2$$

where n=the total number of merge candidates in the sorted list, and k=2. Alternatively, fewer than this number of potential pairwise merge candidates may be considered when selecting pairwise merge candidates for inclusion in the merge candidate list.

In an example embodiment, the pairs with the smallest template costs against the current CU may be included, as pairwise merge candidates, in the merge candidate list.

In an example, similar to the previous example, the following may be a list of the sorted merge candidates, with merge candidate [0] having the smallest template cost (96) against the current CU:
[0] mv(−12,−9) refIdx:0 mv(12,9) refIdx:0 cost:96
[1] mv(−14,−12) refIdx:0 mv(14,12) refIdx:0 cost:110
[2] mv(−7,−9) refIdx:0 mv(7,9) refIdx:0 cost:294
[3] mv(−8,−8) refIdx:0 mv(8,8) refIdx:0 cost:318
[4] mv(−7,−7) refIdx:0 mv(7,7) refIdx:0 cost:456
[5] mv(0,0) refIdx:−1 mv(7,9) refIdx:0 cost:866
[6] mv(−7,−9) refIdx:0 mv(0,0) refIdx:−1 cost:920
[7] mv(0,0) refIdx:−1 mv(8,8) refIdx:0 cost:926
[8] mv(−8,−8) refIdx:0 mv(0,0) refIdx:−1 cost:1020
[9] mv(−7,−7) refIdx:0 mv(0,0) refIdx:−1 cost:1296

However, using the second example of pseudo code, the following four pairwise merge candidates may be included in the merge candidate list, if up to four pairwise merge candidates are allowed in the merge candidate list:
Pair (0,1): (−13,−10) refIdx:0, (13,10) refIdx:0 cost:206
Pair (0,2): (−9,−9) refIdx:0, (9,9) refIdx:0 cost:390
Pair (1,2): (−10,−10) refIdx:0, (10,10) refIdx:0 cost:404
Pair (0,3): (−10,−8) refIdx:0, (10,8) refIdx:0 cost:414

In this example, pair (0,4) with template cost=552 is replaced by pair (1,2) with a smaller template cost=404.

In an example embodiment, to simplify and speed up the selection process, for a pair of merge candidates, instead of calculating the template cost of the pairwise candidate derived from the pair of merge candidates against the current CU, the pair's individual template costs (e.g. their sum, their average, the one with smaller cost, etc.) may be used in determining if the pair should be included in merge candidate list, as a pairwise merge candidate.

A technical effect of example embodiments of the present disclosure may be to increase coding efficiency.

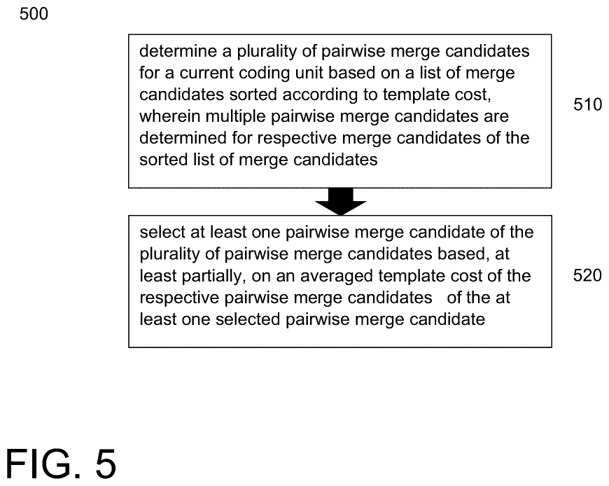

FIG. 5 illustrates the potential steps of an example method 500. The example method 500 may include: determining a plurality of pairwise merge candidates for a current coding unit based on a list of merge candidates sorted according to template cost, wherein multiple pairwise merge candidates are determined for respective merge candidates of the sorted list of merge candidates, 510; and selecting at least one pairwise merge candidate of the plurality of pairwise merge candidates based, at least partially, on an averaged template cost of the respective pairwise merge candidates of the at least one selected pairwise merge candidate, 520. The example method may be performed, for example, with a codec, an encoder, a decoder, a receiver side, a transmitter side, an apparatus configured to receive compressed bits, an apparatus configured to transmit compressed bits, etc.

In accordance with one example embodiment, an apparatus may comprise: at least one processor; and at least one memory storing instructions that, when executed by the at least one processor, cause the apparatus at least to: determine a plurality of pairwise merge candidates for a current coding unit based on a list of merge candidates sorted according to template cost, wherein multiple pairwise merge candidates may be determined for respective merge candidates of the sorted list of merge candidates; and select at least one pairwise merge candidate of the plurality of pairwise merge candidates based, at least partially, on an averaged template cost of the respective pairwise merge candidates of the at least one selected pairwise merge candidate.

The example apparatus may be further configured to: obtain the list of merge candidates for the current coding unit; and sort the list of merge candidates according to template cost with respect to a template of the current coding unit.

The at least one selected pairwise merge candidate may comprise at least one pairwise merge candidate based on two merge candidates other than a merge candidate with a lowest template cost in the list of merge candidates sorted according to template cost.

Selecting the at least one pairwise merge candidate of the plurality of merge candidates may comprise the example apparatus being further configured to: select up to four pairwise merge candidates, of the plurality of merge candidates, with lowest averaged template costs.

Selecting the at least one pairwise merge candidate of the plurality of pairwise merge candidates may comprise the example apparatus being further configured to: determine an average template cost for respective pairwise merge candidates of the plurality of pairwise merge candidates; sort the plurality of pairwise merge candidates according to average template cost; and select a predetermined number of the sorted plurality of pairwise merge candidates with lowest average template costs.

The list of merge candidates may comprise at least one of: a spatial merge candidate, a temporal merge candidate, a non-adjacent merge candidate, or a history-based merge candidate.

The averaged template cost of the respective pairwise merge candidates of the at least one selected pairwise merge candidate may comprise one of: a template cost for the at least one selected pairwise merge candidate, an average of respective template costs of two merge candidates represented with the at least one selected pairwise merge candidate, a sum of the respective template costs of the two merge candidates represented with the at least one selected pairwise merge candidate, or a smaller of the respective template costs of the two merge candidates represented with the at least one selected pairwise merge candidate.

The example apparatus may comprise a decoder, and the example apparatus may be further configured to: decode the current coding unit based, at least partially, on one or more of the at least one selected pairwise merge candidate.

The example apparatus may comprise an encoder, and the example apparatus may be further configured to: encode the current coding unit based, at least partially, on one or more of the at least one selected pairwise merge candidate.

In accordance with one aspect, an example method may be provided comprising: determining a plurality of pairwise merge candidates for a current coding unit based on a list of merge candidates sorted according to template cost, wherein multiple pairwise merge candidates may be determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

The example method may further comprise: obtaining the list of merge candidates for the current coding unit; and sorting the list of merge candidates according to template cost with respect to a template of the current coding unit.

The at least one selected pairwise merge candidate may comprise at least one pairwise merge candidate based on two merge candidates other than a merge candidate with a lowest template cost in the list of merge candidates sorted according to template cost.

The selecting of the at least one pairwise merge candidate of the plurality of merge candidates may comprise: selecting up to four pairwise merge candidates, of the plurality of merge candidates, with lowest averaged template costs.

The selecting of the at least one pairwise merge candidate of the plurality of pairwise merge candidates may comprise: determining an average template cost for respective pairwise merge candidates of the plurality of pairwise merge candidates; sorting the plurality of pairwise merge candidates according to average template cost; and selecting a predetermined number of the sorted plurality of pairwise merge candidates with lowest average template costs.

The list of merge candidates may comprise at least one of: a spatial merge candidate, a temporal merge candidate, a non-adjacent merge candidate, or a history-based merge candidate.

The averaged template cost of the respective pairwise merge candidates of the at least one selected pairwise merge candidate may comprise one of: a template cost for the at least one selected pairwise merge candidate, an average of respective template costs of two merge candidates represented with the at least one selected pairwise merge candidate, a sum of the respective template costs of the two merge candidates represented with the at least one selected pairwise merge candidate, or a smaller of the respective template costs of the two merge candidates represented with the at least one selected pairwise merge candidate.

The example method may be performed with a decoder, wherein the example method may further comprise: decoding the current coding unit based, at least partially, on one or more of the at least one selected pairwise merge candidate.

The example method may be performed with an encoder, wherein the example method may further comprise: encoding the current coding unit based, at least partially, on one or more of the at least one selected pairwise merge candidate.

In accordance with one example embodiment, an apparatus may comprise: circuitry configured to perform: determining a plurality of pairwise merge candidates for a current coding unit based on a list of merge candidates sorted according to template cost, wherein multiple pairwise merge candidates may be determined for respective merge candidates of the sorted list of merge candidates; and circuitry configured to perform: selecting at least one pairwise merge candidate of the plurality of pairwise merge candidates based, at least partially, on an averaged template cost of the respective pairwise merge candidates of the at least one selected pairwise merge candidate.

In accordance with one example embodiment, an apparatus may comprise: processing circuitry; memory circuitry including computer program code, the memory circuitry and the computer program code configured to, with the processing circuitry, enable the apparatus to: determine a plurality of pairwise merge candidates for a current coding unit based on a list of merge candidates sorted according to template cost, wherein multiple pairwise merge candidates may be determined for respective merge candidates of the sorted list of merge candidates; and select at least one pairwise merge candidate of the plurality of pairwise merge candidates based, at least partially, on an averaged template cost of the respective pairwise merge candidates of the at least one selected pairwise merge candidate.

As used in this application, the term “circuitry” or “means” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: determining a plurality of pairwise merge candidates for a current coding unit based on a list of merge candidates sorted according to template cost, wherein multiple pairwise merge candidates may be determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

The means may be further configured for: obtaining the list of merge candidates for the current coding unit; and sorting the list of merge candidates according to template cost with respect to a template of the current coding unit.

The at least one selected pairwise merge candidate may comprise at least one pairwise merge candidate based on two merge candidates other than a merge candidate with a lowest template cost in the list of merge candidates sorted according to template cost.

The means configured for selecting the at least one pairwise merge candidate of the plurality of merge candidates may comprise means configured for: selecting up to four pairwise merge candidates, of the plurality of merge candidates, with lowest averaged template costs.

The means configured for selecting the at least one pairwise merge candidate of the plurality of pairwise merge candidates may comprise means configured for: determining an average template cost for respective pairwise merge candidates of the plurality of pairwise merge candidates; sorting the plurality of pairwise merge candidates according to average template cost; and selecting a predetermined number of the sorted plurality of pairwise merge candidates with lowest average template costs.

The list of merge candidates may comprise at least one of: a spatial merge candidate, a temporal merge candidate, a non-adjacent merge candidate, or a history-based merge candidate.

The averaged template cost of the respective pairwise merge candidates of the at least one selected pairwise merge candidate may comprise one of: a template cost for the at least one selected pairwise merge candidate, an average of respective template costs of two merge candidates represented with the at least one selected pairwise merge candidate, a sum of the respective template costs of the two merge candidates represented with the at least one selected pairwise merge candidate, or a smaller of the respective template costs of the two merge candidates represented with the at least one selected pairwise merge candidate.

The example apparatus may comprise a decoder, wherein the means may be further configured for: decoding the current coding unit based, at least partially, on one or more of the at least one selected pairwise merge candidate.

The example apparatus may comprise an encoder, wherein the means may be further configured for: encoding the current coding unit based, at least partially, on one or more of the at least one selected pairwise merge candidate.

A processor, memory, and/or example algorithms (which may be encoded as instructions, program, or code) may be provided as example means for providing or causing performance of operation.

In accordance with one example embodiment, a (non-transitory) computer-readable medium comprising instructions stored thereon which, when executed with at least one processor, cause the at least one processor to: determine a plurality of pairwise merge candidates for a current coding unit based on a list of merge candidates sorted according to template cost, wherein multiple pairwise merge candidates may be determined for respective merge candidates of the sorted list of merge candidates; and select at least one pairwise merge candidate of the plurality of pairwise merge candidates based, at least partially, on an averaged template cost of the respective pairwise merge candidates of the at least one selected pairwise merge candidate.

In accordance with one example embodiment, a (non-transitory) computer-readable medium comprising program instructions stored thereon for performing at least the following: determining a plurality of pairwise merge candidates for a current coding unit based on a list of merge candidates sorted according to template cost, wherein multiple pairwise merge candidates may be determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

The example computer-readable medium may be further configured for performing: causing obtaining of the list of merge candidates for the current coding unit; and sorting the list of merge candidates according to template cost with respect to a template of the current coding unit.

The at least one selected pairwise merge candidate may comprise at least one pairwise merge candidate based on two merge candidates other than a merge candidate with a lowest template cost in the list of merge candidates sorted according to template cost.

The program instructions stored on the example computer-readable medium for performing selecting the at least one pairwise merge candidate of the plurality of merge candidates may comprise program instructions stored thereon for performing: selecting up to four pairwise merge candidates, of the plurality of merge candidates, with lowest averaged template costs.

The program instructions stored on the example computer-readable medium for performing selecting the at least one pairwise merge candidate of the plurality of merge candidates may comprise program instructions stored thereon for performing: determining an average template cost for respective pairwise merge candidates of the plurality of pairwise merge candidates; sorting the plurality of pairwise merge candidates according to average template cost; and selecting a predetermined number of the sorted plurality of pairwise merge candidates with lowest average template costs.

The list of merge candidates may comprise at least one of: a spatial merge candidate, a temporal merge candidate, a non-adjacent merge candidate, or a history-based merge candidate.

The averaged template cost of the respective pairwise merge candidates of the at least one selected pairwise merge candidate may comprise one of: a template cost for the at least one selected pairwise merge candidate, an average of respective template costs of two merge candidates represented with the at least one selected pairwise merge candidate, a sum of the respective template costs of the two merge candidates represented with the at least one selected pairwise merge candidate, or a smaller of the respective template costs of the two merge candidates represented with the at least one selected pairwise merge candidate.

A decoder may comprise the example computer-readable medium, and the example computer-readable medium may be further configured for performing: decoding the current coding unit based, at least partially, on one or more of the at least one selected pairwise merge candidate.

An encoder may comprise the example computer-readable medium, and the example computer-readable medium may be further configured for performing: encoding the current coding unit based, at least partially, on one or more of the at least one selected pairwise merge candidate.

In accordance with another example embodiment, a (non-transitory) program storage device readable by a machine may be provided, tangibly embodying instructions executable by the machine for performing operations, the operations comprising: determining a plurality of pairwise merge candidates for a current coding unit based on a list of merge candidates sorted according to template cost, wherein multiple pairwise merge candidates may be determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

In accordance with another example embodiment, a (non-transitory) computer-readable medium comprising instructions that, when executed by an apparatus, cause the apparatus to perform at least the following: determining a plurality of pairwise merge candidates for a current coding unit based on a list of merge candidates sorted according to template cost, wherein multiple pairwise merge candidates may be determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

A computer implemented system comprising: at least one processor and at least one (non-transitory) memory storing instructions that, when executed by the at least one processor, cause the system at least to perform: determining a plurality of pairwise merge candidates for a current coding unit based on a list of merge candidates sorted according to template cost, wherein multiple pairwise merge candidates may be determined for respective merge candidates of the sorted list of merge candidates; and selecting at least one pairwise merge candidate of the plurality of pairwise merge candidates based, at least partially, on an averaged template cost of the respective pairwise merge candidates of the at least one selected pairwise merge candidate.

A computer implemented system comprising: means for determining a plurality of pairwise merge candidates for a current coding unit based on a list of merge candidates sorted according to template cost, wherein multiple pairwise merge candidates may be determined for respective merge candidates of the sorted list of merge candidates; and means for selecting at least one pairwise merge candidate of the plurality of pairwise merge candidates based, at least partially, on an averaged template cost of the respective pairwise merge candidates of the at least one selected pairwise merge candidate.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one memory storing instructions that, when executed with the at least one processor, cause the apparatus at least to:
determine a plurality of pairwise merge candidates for a current coding unit based on a list of merge candidates sorted according to a template cost, wherein multiple pairwise merge candidates are determined for respective merge candidates of the sorted list of merge candidates; and
select at least one pairwise merge candidate of the plurality of pairwise merge candidates based, at least partially, on an averaged template cost of the respective pairwise merge candidates of the at least one selected pairwise merge candidate.

2. The apparatus of claim 1, wherein the instructions, when executed with the at least one processor, cause the apparatus to:
obtain the list of merge candidates for the current coding unit; and
sort the list of merge candidates according to template cost with respect to a template of the current coding unit.

3. The apparatus of claim 1, wherein the at least one selected pairwise merge candidate comprises at least one pairwise merge candidate based on two merge candidates other than a merge candidate with a lowest template cost in the list of merge candidates sorted according to the template cost.

4. The apparatus of claim 1, wherein selecting the at least one pairwise merge candidate of the plurality of merge candidates comprises the instructions, when executed with the at least one processor, cause the apparatus to:
select up to four pairwise merge candidates, of the plurality of merge candidates, with lowest averaged template costs.

5. The apparatus of claim 1, wherein selecting the at least one pairwise merge candidate of the plurality of pairwise merge candidates comprises the instructions, when executed with the at least one processor, cause the apparatus to:
determine an average template cost for respective pairwise merge candidates of the plurality of pairwise merge candidates;
sort the plurality of pairwise merge candidates according to average template cost; and
select a predetermined number of the sorted plurality of pairwise merge candidates with lowest average template costs.

6. The apparatus of claim 1, wherein the list of merge candidates comprises at least one of:
a spatial merge candidate,
a temporal merge candidate,
a non-adjacent merge candidate, or
a history-based merge candidate.

7. The apparatus of claim 1, wherein the averaged template cost of the respective pairwise merge candidates of the at least one selected pairwise merge candidate comprises one of:
a template cost for the at least one selected pairwise merge candidate,
an average of respective template costs of two merge candidates represented with the at least one selected pairwise merge candidate,
a sum of the respective template costs of the two merge candidates represented with the at least one selected pairwise merge candidate, or
a smaller of the respective template costs of the two merge candidates represented with the at least one selected pairwise merge candidate.

8. The apparatus of claim 1, wherein the apparatus comprises a decoder, wherein the instructions, when executed with the at least one processor, cause the apparatus to:
decode the current coding unit based, at least partially, on one or more of the at least one selected pairwise merge candidate.

9. The apparatus of claim 1, wherein the apparatus comprises an encoder, wherein the instructions, when executed with the at least one processor, cause the apparatus to:
encode the current coding unit based, at least partially, on one or more of the at least one selected pairwise merge candidate.

10. A method comprising:
determining a plurality of pairwise merge candidates for a current coding unit based on a list of merge candidates sorted according to template cost, wherein multiple pairwise merge candidates are determined for respective merge candidates of the sorted list of merge candidates; and
selecting at least one pairwise merge candidate of the plurality of pairwise merge candidates based, at least partially, on an averaged template cost of the respective pairwise merge candidates of the at least one selected pairwise merge candidate.

11. The method of claim 10, further comprising:
obtaining the list of merge candidates for the current coding unit; and
sorting the list of merge candidates according to template cost with respect to a template of the current coding unit.

12. The method of claim 10, wherein the at least one selected pairwise merge candidate comprises at least one pairwise merge candidate based on two merge candidates other than a merge candidate with a lowest template cost in the list of merge candidates sorted according to template cost.

13. The method of claim 10, wherein the selecting of the at least one pairwise merge candidate of the plurality of merge candidates comprises:
selecting up to four pairwise merge candidates, of the plurality of merge candidates, with lowest averaged template costs.

14. The method of claim 10, wherein the selecting of the at least one pairwise merge candidate of the plurality of pairwise merge candidates comprises:
determining an average template cost for respective pairwise merge candidates of the plurality of pairwise merge candidates;
sorting the plurality of pairwise merge candidates according to the average template cost; and
selecting a predetermined number of the sorted plurality of pairwise merge candidates with lowest average template costs.

15. The method of claim 10, wherein the list of merge candidates comprises at least one of:
a spatial merge candidate,
a temporal merge candidate,
a non-adjacent merge candidate, or
a history-based merge candidate.

16. The method of claim 10, wherein the averaged template cost of the respective pairwise merge candidates of the at least one selected pairwise merge candidate comprises one of:
a template cost for the at least one selected pairwise merge candidate,
an average of respective template costs of two merge candidates represented with the at least one selected pairwise merge candidate,
a sum of the respective template costs of the two merge candidates represented with the at least one selected pairwise merge candidate, or
a smaller of the respective template costs of the two merge candidates represented with the at least one selected pairwise merge candidate.

17. The method of claim 10, wherein the method is performed with a decoder, wherein the method further comprises:
decoding the current coding unit based, at least partially, on one or more of the at least one selected pairwise merge candidate.

18. The method of claim 10, wherein the method is performed with an encoder, wherein the method further comprises:
encoding the current coding unit based, at least partially, on one or more of the at least one selected pairwise merge candidate.

19. A computer-readable medium comprising program instructions stored thereon for performing at least the following:
determining a plurality of pairwise merge candidates for a current coding unit based on a list of merge candidates sorted according to template cost, wherein multiple pairwise merge candidates are determined for respective merge candidates of the sorted list of merge candidates; and
selecting at least one pairwise merge candidate of the plurality of pairwise merge candidates based, at least partially, on an averaged template cost of the respective pairwise merge candidates of the at least one selected pairwise merge candidate.

20. The computer-readable medium of claim 19, further comprising program instructions stored thereon for performing:
causing obtaining of the list of merge candidates for the current coding unit; and
sorting the list of merge candidates according to template cost with respect to a template of the current coding unit.
